(19) United States
(12) Patent Application Publication
(10) Pub. No.: US 2019/0277467 A1
(43) Pub. Date: Sep. 12, 2019

(54) PRESENTATION APPARATUS

(71) Applicant: Panasonic Intellectual Property Management Co., Ltd., Osaka (JP)

(72) Inventors: HIROSHI TAKAHASHI, Kanagawa (JP); NAGANORI SHIRAKATA, Kanagawa (JP); JUNICHI MORITA, Tokyo (JP); KAZUMA NISHIYASU, Kanagawa (JP); MEI OKAMOTO, Kanagawa (JP)

(21) Appl. No.: 16/286,234

(22) Filed: Feb. 26, 2019

(30) Foreign Application Priority Data
Mar. 9, 2018 (JP) 2018-043196

(51) Int. Cl. F21S 10/04; H05B 33/08; H05B 37/02

(52) U.S. Cl. CPC F21S 10/043; F21Y 2115/10; H05B 37/0272; H05B 33/0842

(57) ABSTRACT

A presentation apparatus includes a controller that includes a first output terminal for outputting a control signal and first to nth light emitters that each include a first input terminal to which the control signal is input and that is each attachable to the controller in a stacking manner and detachable from the controller. The control signal is transferred to the first to nth light emitters in a stacking order via an electrical serial connection.

### BACKGROUND

### 1. Technical Field

The present disclosure relates to a presentation apparatus.

### 2. Description of the Related Art

In recent years, a presentation that provides the audience with a dramatic experience by using presentation apparatuses possessed by the audience is often shown at events held at facilities that are able to accommodate large audiences, such as stadiums and halls. Another example is wedding venues, where a wide variety of presentations using presentation apparatuses installed at the venues are shown.

As an example of such presentation apparatuses, U.S. Pat. No. 8,070,319 discloses a presentation apparatus that has a candle-shaped structure and that simulates a candle flame by using a light emitting diode (LED) light.

### SUMMARY

However, the structure disclosed in U.S. Pat. No. 8,070,319 can be used in only limited scenarios and thus has a difficulty in being adapted to a wide variety of presentations depending on a usage scenario (and/or a use case).

One non-limiting and exemplary embodiment provides a presentation apparatus that can be used for a wide variety of presentations depending on a usage scenario.

In one general aspect, the techniques disclosed here feature a presentation apparatus including a controller that includes a first output terminal for outputting a control signal and first to nth (n is an integer equal to or more than 1) light emitters that each include a first input terminal to which the control signal is input and that is each attachable to the controller in a stacking manner and detachable from the controller. The control signal is transferred to the first to nth light emitters in a stacking order via an electrical serial connection.

It should be noted that general or specific embodiments may be implemented as a system, an integrated circuit, a computer program, a storage medium, or any selective combination thereof.

One aspect of the present disclosure provides a presentation apparatus that can be used for a wide variety of presentation depending on a usage scene.

Additional benefits and advantages of one aspect of the present disclosure will become apparent from the specification and drawings. The benefits and/or advantages may be individually obtained by the various embodiments and features of the specification and drawings, which need not all be provided in order to obtain one or more of the same features.

### BRIEF DESCRIPTION OF THE DRAWINGS

FIG. 1 illustrates an example of a configuration of a presentation apparatus according to a first embodiment of the present disclosure;

FIG. 2 illustrates an example of a configuration of the presentation controller according to the first embodiment of the present disclosure;

FIG. 3 is a perspective view illustrating an example of an exterior of the presentation controller according to the first embodiment of the present disclosure;

FIG. 4 is a top view illustrating an example of the exterior of the presentation controller according to the first embodiment of the present disclosure;

FIG. 5 illustrates an example of a configuration of a first light emitter according to the first embodiment of the present disclosure;

FIG. 6 is a top view illustrating an example of an exterior of the first light emitter according to the first embodiment of the present disclosure;

FIG. 7 is a bottom view illustrating an example of the exterior of the first light emitter according to the first embodiment of the present disclosure;

FIG. 8 is a side view illustrating an example of the exterior of the first light emitter according to the first embodiment of the present disclosure;

FIG. 9 illustrates an example of a configuration of the second light emitter according to the first embodiment of the present disclosure;

FIG. 10 is a bottom view illustrating an example of an exterior of the second light emitter according to the first embodiment of the present disclosure;

FIG. 11 illustrates an example of a connected state of the presentation apparatus according to the first embodiment of the present disclosure;

FIG. 12 illustrates an example of control data according to the first embodiment of the present disclosure;

FIG. 13 illustrates an example of a presentation system according to the first embodiment of the present disclosure;

FIG. 14 illustrates an example of a configuration of an access point according to the first embodiment of the present disclosure;

FIG. 15 illustrates an example of a light-emitter-information notification packet according to the first embodiment of the present disclosure;

FIG. 16 illustrates an example of a configuration of a control packet according to the first embodiment of the present disclosure;

FIG. 17 illustrates another example of a configuration of a presentation apparatus according to the first embodiment of the present disclosure;

FIG. 18 illustrates a further example of a configuration of a presentation apparatus according to the first embodiment of the present disclosure;

FIG. 19 illustrates an example of a configuration of a presentation apparatus according to a second embodiment of the present disclosure;

FIG. 20 illustrates an example of a configuration of the presentation controller according to the second embodiment of the present disclosure; and

FIG. 21 illustrates an example of a configuration of a sensor control unit according to the second embodiment of the present disclosure.

### DETAILED DESCRIPTION

Embodiments of the present disclosure are described in detail below with reference to the drawings. It should be noted that the embodiments described below are mere examples and are not intended to limit the present disclosure.

### First Embodiment

A first embodiment of the present disclosure is described in detail with reference to the drawings.

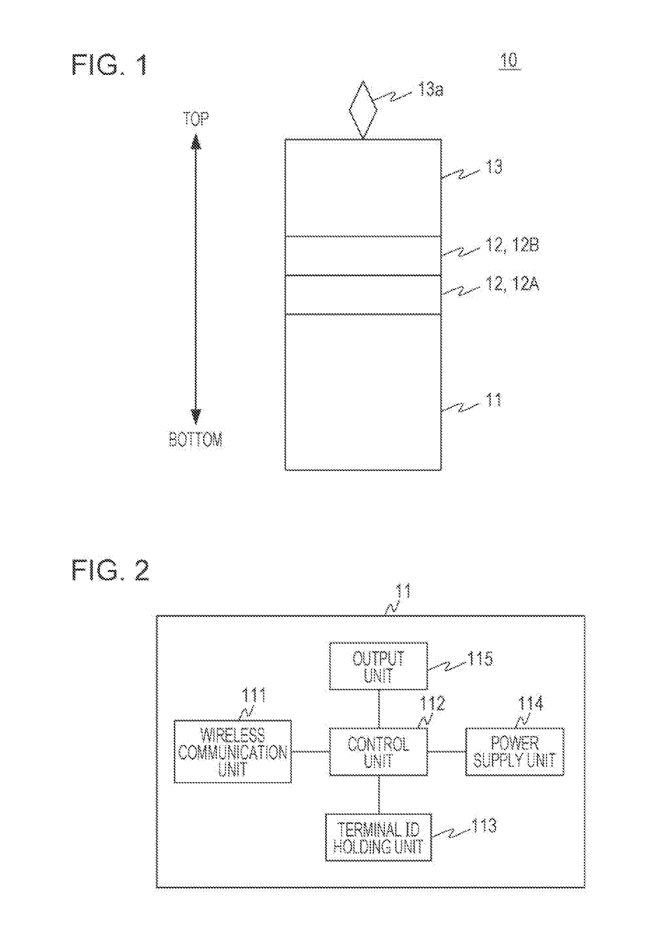

FIG. 1 illustrates an example of a configuration of a presentation apparatus 10 according to the first embodiment. The presentation apparatus 10 includes, for example, a presentation controller 11, a first light emitter 12A and a first light emitter 12B, and a second light emitter 13.

An arrow indicating longitudinal direction is shown in FIG. 1. In the following description, the longitudinal direction is a direction indicated by, the arrow in FIG. 1. The description based on the longitudinal direction of the arrow in FIG. 1 is as follows: the first light emitter 12A is attached to the presentation controller 11 in a stacked manner; the first light emitter 12B is attached to the first light emitter 12A in a stacked manner; and the second light emitter 13 is attached to the first light emitter 12B in a stacked manner. The direction indicated by the arrow in FIG. 1 may also be referred to as a stacking direction.

The presentation apparatus 10 is, for example, a candle-shaped LED light that is used in a static position. The first light emitter 12A and the first light emitter 12B each have a cylindrical body whose axis extends in the stacking direction. Both the side surface of the cylinder of the first light emitter 121 and the side surface of the cylinder of the first light emitter 12B emit light. The second light emitter 13 has a cylindrical body and a head 13a that is on the body and that mimics the shape of a candle flame. Concerning the second light emitter 13, the head 13a, for example, emits light.

The configuration of the first light emitter 12A and the configuration of the first light emitter 12B are identical. When the first light emitter 12A and the first light emitter 12B are not distinguished from each other, the first light emitter 12A and the first light emitter 12B may each also be referred to as a first light emitter 12. The first light emitter 12 and the second light emitter 13 may also be referred to as a light emitter without distinguishing between them.

The presentation controller (presentation control circuit) 11 may also be referred to as a presentation control device, a presentation control unit, or a control unit. The light emitter may also be referred to as a light-emitting device or a light-emitting unit. The first light emitter 12 may also be referred to as a first light-emitting device or a first light-emitting unit. The second light emitter 13 may also be referred to as a second light-emitting device or a second light-emitting unit.

Furthermore, the presentation controller 11 may also be referred to as a docking station, to which the light emitter is docked.

Next, the presentation controller 11, the first light emitter 12, and the second light emitter 13, which are all included in the presentation apparatus 10, are individually described.

### Presentation Controller 11

FIG. 2 illustrates an example of a configuration of the presentation controller 11 according to the first embodiment. The presentation controller 11 includes a wireless communication unit (wireless communication circuit) 111, a control unit (control circuit) 112, a terminal identifier (ID) holding unit (terminal ID holding circuit) 113, a power supply unit (power supply circuit) 114, and an output unit (output terminal) 115.

The wireless communication unit 111 includes an antenna and a signal processor. The wireless communication unit 111 communicates wirelessly with a control device (for example, an access point (AP) 20 described later (see FIG. 13)) under the control of the control unit 112. The wireless communication unit 111 operates in accordance with a communication standard or a communication system such as a specified low power wireless communication, a wireless local area network (LAN), or Bluetooth (registered trademark). The wireless communication unit 111 may operate in accordance with any communication standards such as low power wide area (LPWA), LoRa, narrow band-Internet of things (NB-IoT), Sigfox, and cellular communication, which all cover areas broader than the area covered by the Bluetooth communication standard.

The control unit 112 controls the wireless communication unit 111, the terminal ID holding unit 113, and the output unit 115.

For example, to obtain the number of first light emitters 12 and the second light emitters 13 that are included in the presentation apparatus 10, the control unit 112 outputs a control command for checking the number (hereinafter referred to as the number-check control command) to the first light emitter 12 and the second light emitter 13. For example, the control unit 112 outputs the number-check control command multiple times until there is no reply from the first light emitter 12 or the second light emitter 13. The timing when the control unit 112 starts outputting the number-check control command is, for example, the timing after the presentation apparatus 10 starts operation or the timing when a light-emitter-information collection packet is received from an access point. The presentation apparatus 10 starts operation by, for example, receiving power that is supplied under the control of a user or the remote control of an access point.

An example of processing for the number-check control command and an example of the light-emitter-information collection packet will be described later.

For example, after the presentation apparatus 10 starts operation, the control unit 112 controls power from the power supply unit 114 to be supplied to the wireless communication unit 111 and the terminal ID holding unit 113. The control unit 112 also controls power to be supplied to the first light emitter 12A, the first light emitter 12B, and the second light emitter 13 via the output unit 115.

Furthermore, for example, the control unit 112 obtains via the wireless communication unit 111 a control packet containing control data for controlling the presentation apparatus 10 and controls the presentation apparatus 10 in accordance with a presentation pattern included in the control data. Specifically, the control unit 112 outputs via the output unit 115 a control signal for transferring the control data and controls the first light emitter 12A, the first light emitter 12B, and the second light emitter 13.

An example of the control data and an example of the control packet will be described later.

The terminal ID holding unit 113 holds an ID unique to the presentation apparatus 10. The unique ID of the presentation apparatus 10 includes, for example, at least one of a media access control (MAC) address, a device address, and a device ID. The terminal ID holding unit 113 may hold a group ID assigned to a group including multiple presentation apparatuses 10. The group ID is assigned by, for example, a control apparatus (for example, the AP 20 described later (see FIG. 13)).

The power supply unit 114 supplies power to, for example, the control unit 112. The power supply unit 114 is, for example, a battery that is mounted inside the presentation apparatus 10. The power supply unit 114 is not limited to a battery, but a solar cell and/or energy harvesting may be used for the power supply unit 114.

The output unit 115 outputs the control signal obtained from the control unit 112 to the first light emitter 12A described in detail later. The output unit 115 is coupled to an input unit 121 of the first light emitter 12A described in detail later. A communication system such as serial communication and/or I2C may be employed for output and input of signals between the output unit 115 and the input unit 121.

The output unit 115 may be coupled to an input unit 131 of the second light emitter 13 described in detail later. A communication system such as serial communication and/or I2C may be employed for output and input of signals between the output unit 115 and the input unit 131.

The output unit 115 may be a terminal for outputting and inputting signals. The output unit 115 may be referred to as an output terminal included in the presentation controller 11 (control unit).

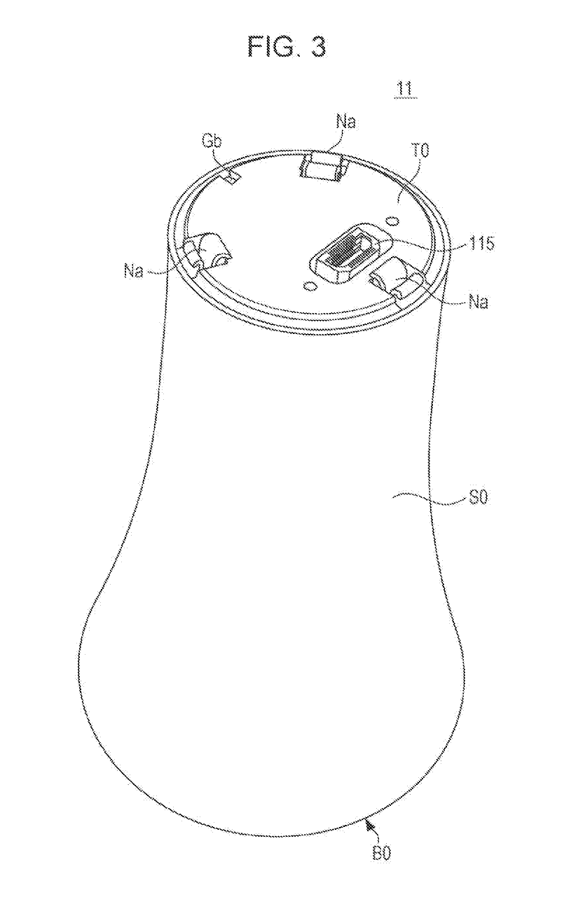

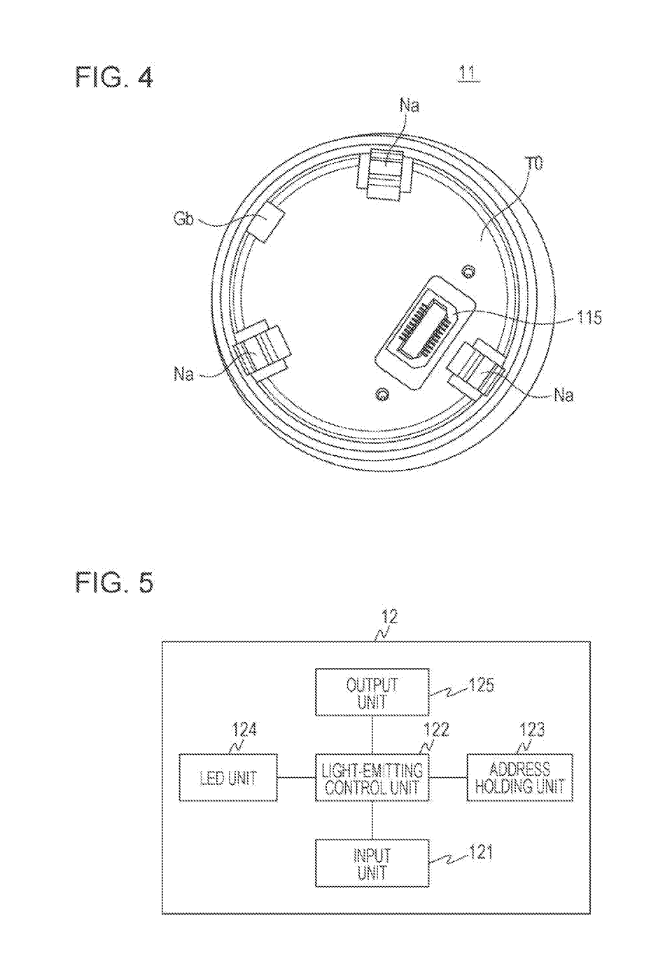

Next, an example of an exterior of the presentation controller 11 is described. FIG. 3 is a perspective view illustrating an example of an exterior of the presentation controller 11 according to the first embodiment. FIG. 4 is a top view illustrating an example of the exterior of the presentation controller 11 according to the first embodiment.

The presentation controller 11 has a housing including a circular bottom B0, a circular top T0 smaller than the circle of the bottom B0, and a side S0 that smoothly connects the top T0 and the bottom B0 to each other.

The output unit 115 projects from the top T0. Three catches Na and a guide receiving portion Gb are provided at the edge of the top T0. The catch Na is fitted into a catch receiving portion Nb that is provided at the bottom of the light emitter described later. A guide Ga, which is provided at the bottom of the light emitter described later, is fitted into the guide receiving portion Gb.

### First Light Emitter 12

FIG. 5 illustrates an example of a configuration of the first light emitter 12 according to the first embodiment. The first light emitter 12 includes an input unit (input terminal) 121, a light-emitting control unit (light-emitting control circuit) 122, an address holding unit (address holding circuit) 123, an LED unit (LED circuit) 124, and an output unit (output terminal) 125.

The input unit 121 of the first light emitter 12 obtains the control signal for transferring the control data from the presentation controller 11 or another first light emitter 12 and outputs the control signal to the light-emitting control unit 122. The input unit 121 may be a terminal for inputting and outputting signals. The input unit 121 may be referred to as an input terminal included in the first light emitter 12.

The address holding unit 123 holds an address indicating the first light emitter 12. For example, the address holding unit 123 of the first light emitter 12A holds the address of the first light emitter 12A, and the address holding unit 123 of the first light emitter 12B holds the address of the first light emitter 12B.

The address held by the address holding unit 123 may be a unique identifier that is uniquely determined with respect to the first light emitter 12 or an identifier that is arbitrarily set by a user of the presentation apparatus 10.

The address held by the address holding unit 123 may also be an identifier that is assigned by the presentation controller 11 after the first light emitter 12 has replied to the number-check control command.

In a case where the address that is contained in the control data obtained from the input unit 121 coincides with the address that is obtained from the address holding unit 123, the light-emitting control unit 122 controls the light-emitting pattern of the LED unit 124 in accordance with light-emitting information corresponding to an identical address contained in the control data.

Regardless of whether the addresses coincides with each other, the light-emitting control unit 122 outputs to the output unit 125 the control data obtained from the input unit 121.

The light-emitting control unit 122 of the first light emitter 12 supplies to the address holding unit 123 and the LED unit 124 power supplied from the presentation controller 11 or another first light emitter 12. When another input unit (for example, the input unit 121 of another first light emitter 12 or the input unit 131 of the second light emitter 13) is coupled to the output unit 125 of the first light emitter 12, the light-emitting control unit 122 of the first light emitter 12 supplies power via the output unit 125 to the other coupled input unit.

The output unit 125 outputs the control signal for transferring the control data obtained from the light-emitting control unit 122. The output unit 125 may be a terminal for outputting and inputting signals. The output unit 125 may be referred to as an output terminal included in the first light emitter 12.

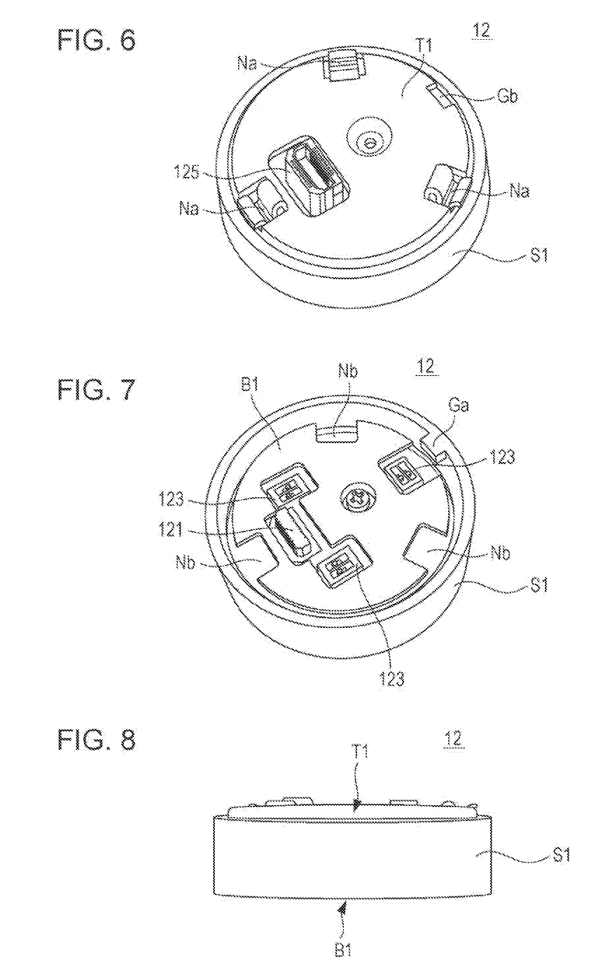

Next, an example of an exterior of the first light emitter 12 is described. FIG. 6 is a top view illustrating an example of an exterior of the first light emitter 12 according to the first embodiment. FIG. 7 is a bottom view illustrating an example of the exterior of the first light emitter 12 according to the first embodiment. FIG. 8 is a side view illustrating an example of the exterior of the first light emitter 12 according to the first embodiment.

The first light emitter 12 has a cylindrical shape whose axis extends in the stacking direction. For example, the first light emitter 12 has a housing including a circular bottom B1, a circular top T1 of the same size as the bottom B1, and a side S1 that connects the top Ti and the bottom B1 to each other.

The output unit 125 projects from the top T1. Three catches Na and a guide receiving portion Gb are provided at the edge of the top T0. The catch Na is fitted into a catch receiving portion Nb that is provided at a bottom B1 of another first light emitter 12 or a catch receiving portion Nb that is provided at a bottom of the second light emitter 13 described in detail later. A guide Ga that is provided at the bottom B1 of the other first light emitter 12 or a guide Ga that is provided at the bottom of the second light emitter 13 described in detail later is fitted into the guide receiving portion Gb.

The input unit 121 projects from the bottom 31. Catch receiving portions Nb and a guide Ga are provided at the edge of the bottom B1. A catch Na that is provided on the top T1 of the other first light emitter 12 or the catch Na that is provided on the top T0 of the presentation controller 11 is fitted into the catch receiving portion Nb. The guide Ga is fitted into the guide receiving portion Gb that is provided to the top T1 of the other first light emitter 12 or the guide receiving portion Gb that is provided to the top T0 of the presentation controller 11.

The address holding unit 123 is provided at the bottom 31. The address holding unit 123 illustrated in FIG. 7 has multiple switches and is provided at a position where a user is able to operate the address holding unit 123. The user switches the multiple switches individually to set an address. It is possible that the address holding unit 123 is not operable for a user. For example, in a case where the address held by the address holding unit 123 is a unique identifier that is uniquely determined with respect to the first light emitter 12, it is possible that the address holding unit 123 is not provided at the bottom 31.

The side S1 is formed from a translucent material. The side S1 emits light such that the LED unit 124 emits light and the side S1 transmits the light.

For example, the bottom B1 of the first light emitter 12 and the top T0 of the presentation controller 11 are positioned to face each other and the input unit 121 and the output unit 115 are coupled to each other, so that the first light emitter 12 may be attached to the presentation controller 11. The attached first light emitter 12 is detachable from the presentation controller 11.

For example, the bottom B1 of the first light emitter 12 (for example, the first light emitter 12B) and the top T1 of another first light emitter 12 (for example, the first light emitter 12A) are positioned to face each other and the input unit 121 of the first light emitter 12B and the output unit 115 of the first light emitter 12A are coupled to each other, so that the first light emitter 123 may be attached to the first light emitter 12A. The attached first light emitter 12B is detachable from the first light emitter 12A.

### Second Light Emitter 13

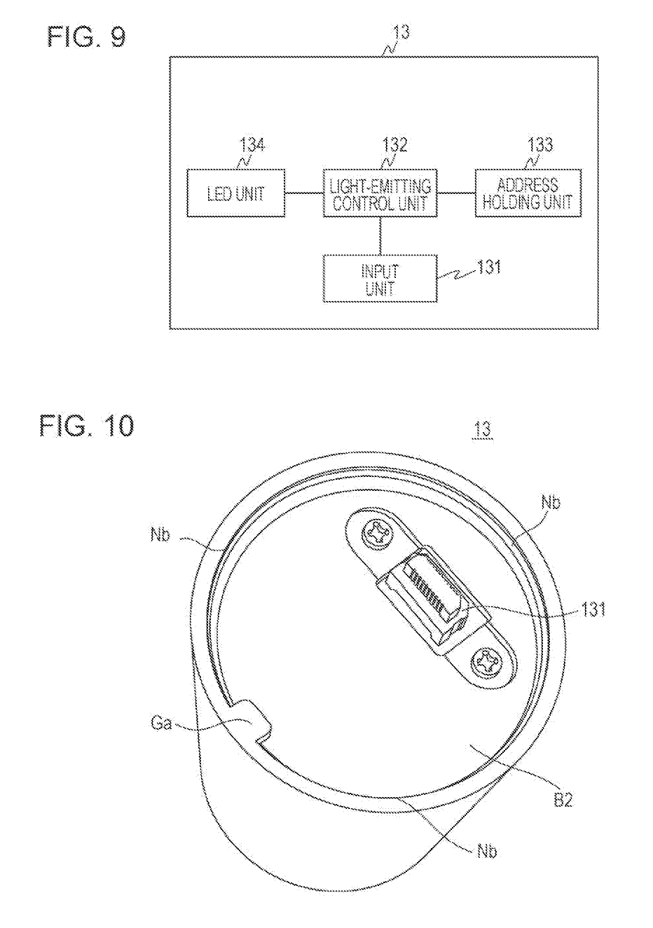

FIG. 9 illustrates an example of a configuration of the second light emitter 13 according to the first embodiment. The second light emitter 13 includes the input unit 131, a light-emitting control unit 132, an address holding unit 133, and an LED unit 134.

The input unit 131 obtains from the presentation controller 11 or the first light emitter 12 the control signal for transferring the control data and outputs the control signal to the light-emitting control unit (light-emitting control circuit) 132. The input unit (input terminal) 131 may be a terminal for inputting and outputting signals. The input unit 131 may be an input terminal included in the second light emitter 13.

The address holding unit (address holding circuit) 133 holds an address indicating the second light emitter 13.

The address held by the address holding unit 133 may be a unique identifier that is uniquely determined with respect to the second light emitter 13 or an identifier that is arbitrarily set by a user of the presentation apparatus 10.

The address held by the address holding unit 133 may also be an identifier that is assigned by the presentation controller 11 after the second light emitter 13 has replied to the number-check control command.

In a case where the address that is contained in the control data obtained from the input unit 131 coincides with the address that is obtained from the address holding unit 133, the light-emitting control unit 132 controls the light-emitting pattern of the LED unit 134 in accordance with light-emitting information corresponding to an identical address contained in the control data.

The light-emitting control unit 132 supplies to the address holding unit 133 and the LED unit 134 power supplied from the presentation controller 11 or the first light emitter 12.

Next, an example of an exterior of the second light emitter 13 is described. FIG. 10 is a bottom view illustrating an example of an exterior of the second light emitter 13 according to the first embodiment.

The input unit 131 projects from a bottom B2. A catch receiving portion Nb and a guide Ga are provided at the edge of the bottom B2. The catches Na that are provided at the top of the first light emitter 12 or the catches Na that are provided at the top of the presentation controller 11 are fitted into the catch receiving portion Nb. The guide Ga is fitted into the guide receiving portion Gb that is provided at the top of the first light emitter 12 or the guide receiving portion Gb that is provided at the top of the presentation controller 11.

For example, the bottom B2 of the second light emitter 13 and the top T0 of the presentation controller 11 are positioned to face each other and the input unit 131 and the output unit 115 are coupled to each other, so that the second light emitter 13 may be attached to the presentation controller 11. The attached second light emitter 13 is detachable from the presentation controller 11.

For example, the bottom B2 of the second light emitter 13 and the top T1 of the first light emitter 12 are positioned to face each other and the input unit 131 and the output unit 125 are coupled to each other, so that the second light emitter 13 may be attached to the first light emitter 12. The attached second light emitter 13 is detachable from the first light emitter 12.

### Presentation Apparatus 10

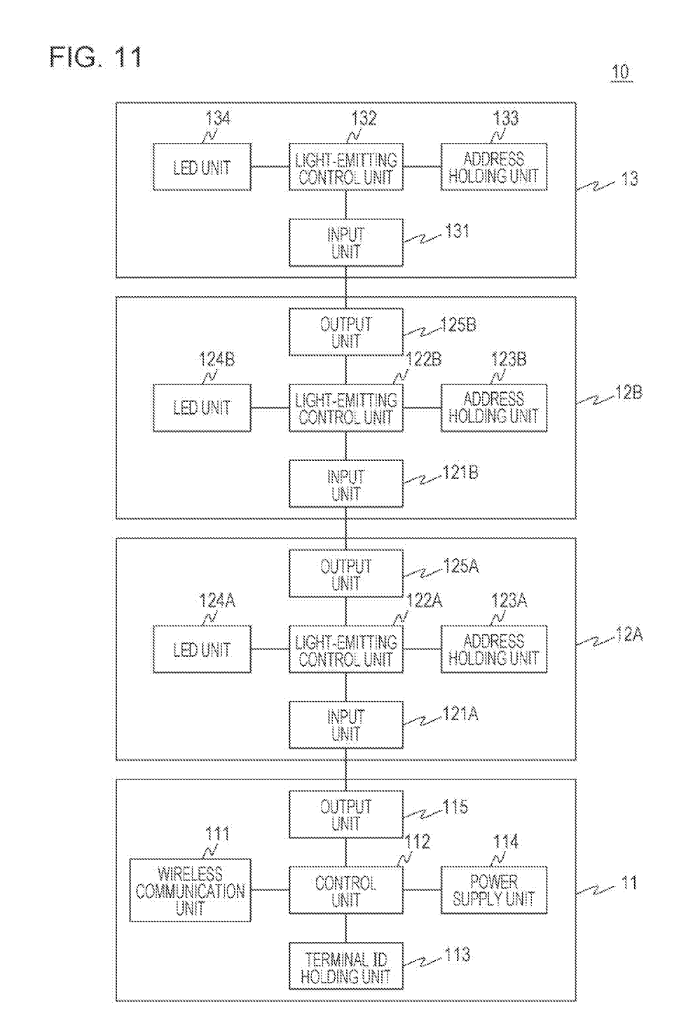

FIG. 11 illustrates an example of a connected state of the presentation apparatus 10 according to the first embodiment. The presentation apparatus 10 illustrated in FIG. 11 is an example in which the presentation controller 11, the first light emitter 12, and the second light emitter 13 are in the connected state as illustrated in FIG. 1.

In the following description, the functional blocks included in the first light emitter 12A may be respectively referred to as an input unit 121A, a light-emitting control unit 122A, an address holding unit 123A, an LED unit 124A, and an output unit 125A. Likewise, the functional blocks included in the first light emitter 12B may be respectively referred to as an input unit 121B, a light-emitting control unit 122B, an address holding unit 123B, an LED unit 124B, and an output unit 125B.

In the example in FIG. 11, the light emitters (light-emitting units) are attached to the presentation controller 11 (control unit) in a stacking manner. The output unit 115 of the presentation controller 11 and the input unit 121A of the first light emitter 12A are coupled to each other, the output unit 125A of the first light emitter 12A and the input unit 121B of the first light emitter 12B are coupled to each other, and the output unit 125B of the first light emitter 12B and the input unit 131 of the second light emitter 13 are coupled to each other. The input units and the output units are coupled to each other and an electrical serial connection (cascade connection) is formed.

For example, the input unit 121A and the output unit 125A of the first light emitter 12A, the input unit 121B and the output unit 125A of the first light emitter 12B, and the input unit 131 of the second light emitter 13 are disposed coaxially in the stacking direction. By coaxially disposing the input units and the output units, the structure of the presentation apparatus 10 can be rigid and the length of the wiring can be minimized.

For example, in the presentation apparatus 10 in FIG. 11, to obtain the number of the first light emitter 12 and the second light emitter 13, the control unit 112 of the presentation controller 11 outputs the control command for checking the number to the first light emitter 12 and the second light emitter 13.

In addition, for example, in the presentation apparatus 10 in FIG. 11, the wireless communication unit 111 of the presentation controller 11 receives the control packet from, for example, an AP. The control unit 112 outputs the control data contained in the received control packet to the first light emitter 12A via the output unit 115.

An example of processing for the number-check control command in the presentation apparatus 10 and an example of the control data and processing for the light emitters with respect to the control data are described below.

### Processing for Number-Check Control Command

In the presentation apparatus 10 in FIG. 11, the control unit 112 outputs the number-check control command (first number-check control command) to the light-emitting control unit 122A of the first light emitter 12A.

The light-emitting control unit 122A obtains the number-check control command from the control unit 112. The light-emitting control unit 122A outputs to the control unit 112 a reply containing an address and type information that are held by the address holding unit 123A. The type information indicates whether the light emitter is the first light emitter 12 or the second light emitter 13. For example, the type information that is contained in the reply output by the light-emitting control unit 122A indicates that the light emitter is the first light emitter 12.

The light-emitting control unit 122A holds information indicating that the light-emitting control unit 122A has replied to the number-check control command.

The control unit 112 obtains from the light-emitting control unit 122A the reply to the number-check control command. The control unit 112 holds the address and the type information of the first light emitter 12A that are contained in the reply. The control unit 112 outputs to the light-emitting control unit 122A a subsequent number-check control command (second number-check control command).

The light-emitting control unit 122A obtains from the control unit 112 the number-check control command. Since the light-emitting control unit 122A has replied to the number-check control command, the light-emitting control unit 122A outputs the number-check control command to the light-emitting control unit 122B of the first light emitter 12B.

The light-emitting control unit 122B obtains from the light-emitting control unit 122A the number-check control command. The light-emitting control unit 122B outputs to the light-emitting control unit 122A a reply containing an address and type information that are held by the address holding unit 123B. For example, the type information that is contained in the reply output from the light-emitting control unit 122B indicates that the light emitter is the first light emitter 12.

The light-emitting control unit 122B holds information indicating that the light-emitting control unit 122B has replied to the number-check control command.

The light-emitting control unit 122A obtains from the light-emitting control unit 122B the reply to the number-check control command and outputs the obtained reply to the control unit 112.

The control unit 112 obtains from the light-emitting control unit 122A the reply to the number-check control command. The control unit 112 holds the address and the type information of the first light emitter 123 that are contained in the reply. The control unit 112 outputs to the light-emitting control unit 122A a subsequent number-check control command (third number-check control command).

The light-emitting control unit 122A obtains from the control unit 112 the number-check control command. Since the light-emitting control unit 122A has replied to the number-check control command, the light-emitting control unit 122A outputs the number-check control command to the light-emitting control unit 122B of the first light emitter 12B.

The light-emitting control unit 122B obtains from the light-emitting control unit 122A the number-check control command. Since the light-emitting control unit 122B has replied to the number-check control command, the light-emitting control unit 122B outputs the number-check control command to the light-emitting control unit 132 of the second light emitter 13.

The light-emitting control unit 132 obtains the number-check control command from the light-emitting control unit 122B. The light-emitting control unit 132 outputs to the light-emitting control unit 122B a reply containing an address and type information that are held by the address holding unit 133. For example, the type information that is contained in the reply output by the light-emitting control unit 132 indicates that the light emitter is the second light emitter 13.

The light-emitting control unit 132 holds information indicating that the light-emitting control unit 132 has replied to the number-check control command.

The light-emitting control unit 122B obtains from the light-emitting control unit 132 the reply to the number-check control command and outputs the obtained reply to the light-emitting control unit 122A. The light-emitting control unit 122A receives from the light-emitting control unit 122B the reply to the number-check control command and outputs the obtained reply to the control unit 112.

The control unit 112 obtains from the light-emitting control unit 122A the reply to the number-check control command. The control unit 112 holds the address and the type information of the second light emitter 13 that are contained in the reply. The control unit 112 outputs to the light-emitting control unit 122A a subsequent number-check control command (fourth number-check control command).

Since the light-emitting control unit 122A has replied to the number-check control command, the light-emitting control unit 122A outputs the number-check control command to the light-emitting control unit 122B of the first light emitter 12B. Since the light-emitting control unit 122B has replied to the number-check control command, the light-emitting control unit 122B outputs the number-check control command to the light-emitting control unit 132 of the second light emitter 13. Since the light-emitting control unit 132 has replied to the number-check control command, the light-emitting control unit 132 does not reply to the number-check control command. For example, the light-emitting control unit 132 discards the received number-check control command.

The control unit 112 obtains the replies to the first to third number-check control commands but does not obtain a reply to the fourth number-check control command. In this case, the control unit 112 recognizes that the number of the light emitters included in the presentation apparatus 10 is three. The control unit 112 also recognizes that, in the presentation apparatus 10, in the order from the closest to the presentation controller 11, the light emitter that has replied to the first number-check control command, the light emitter that has replied to the second number-check control command, and the light emitter that has replied to the third number-check control command are coupled to the presentation controller.

As described above, the control unit 112 outputs the number-check control command multiple times until there is no reply from any light emitter. The light emitters each transmit to the control unit 112 a reply to the number-check control command. In accordance with the replies to the number-check control command obtained from the light emitters, the control unit 112 recognizes, with respect to the presentation apparatus 10, the number of stacked light emitters, the connection order of the light emitters, the addresses of the respective light emitters, and the types of the respective light emitters.

it should be noted that the information on the light emitter that the control unit 112 obtains by outputting the number-check control command is not limited to the number of the light emitters, the connection order of the light emitters, the addresses of the respective light emitters, and the types of the respective light emitters. For example, the information on the light emitter may include at least one of the number of the light emitters, the connection order of the light emitters, the addresses of the respective light emitters, and the types of the respective light emitters. In addition, the reply to the number-check control command may not include the type information when the reply includes at least the address.

### Control Data and Processing for Light Emitters

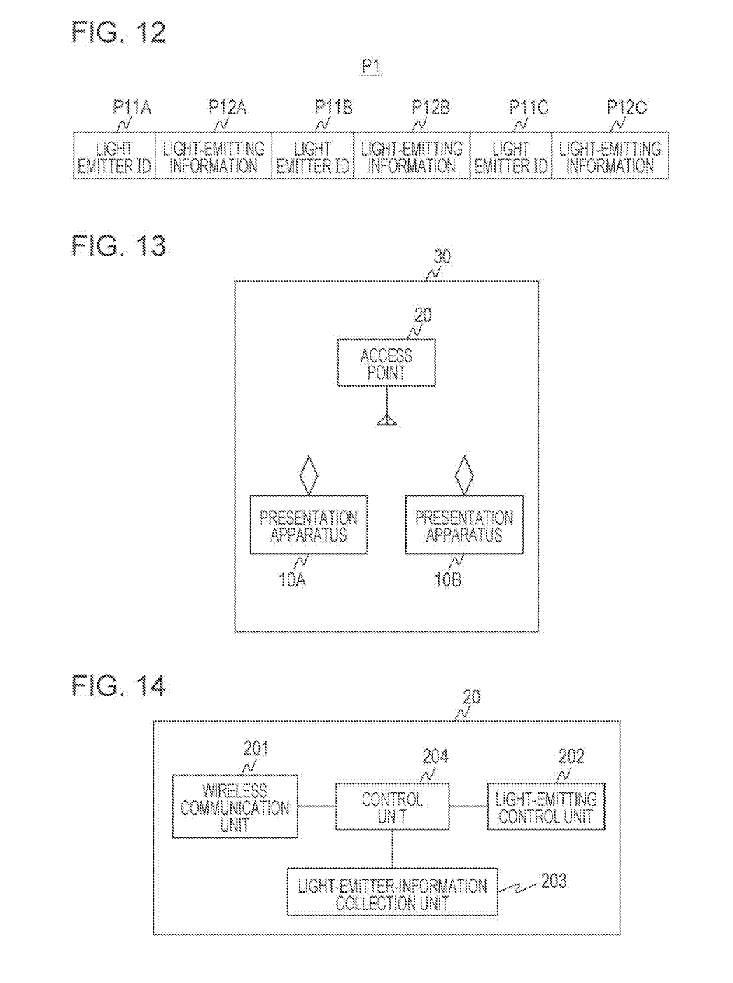

FIG. 12 illustrates an example of control data P1 according to the first embodiment. The control data P1 in FIG. 12 includes data for controlling the presentation apparatus 10 in FIG. 11.

The control data P1 includes a light emitter ID field P11 and light-emitting information field P12 pair (hereinafter also referred to as the field pair). The control data P1 includes multiple field pairs. The number of the field pairs is determined in accordance with the number of the first light emitter 12 and the second light emitter 13 included in the presentation apparatus 10. For example, the control data P1 in FIG. 12 is used for controlling the presentation apparatus 10 illustrated in FIG. 11 that includes the two first light emitters 12 and the one second light emitter 13, and therefore, the number of the field pairs is three.

Hereinafter, for convenience of description, the fields of the first field pair are named a light emitter ID field P11A and a light-emitting information field P12A; the fields of the second field pair are named a light emitter ID field P11B and a light-emitting information field P12B, and the fields of the third field pair are named a light emitter ID field P11C and a light-emitting information field P12C, respectively.

The light emitter ID field P11A and the light-emitting information field P12A contains information corresponding to the first light emitter 12A, the light emitter ID field P11B and the light-emitting information field P12B contains information corresponding to the first light emitter 12B, and the light emitter ID field P11C and the light-emitting information field P12C contains information corresponding to the second light emitter 13.

The light emitter ID field P11 contains the address of the light emitter. For example, the light emitter ID fields P11A, P11B, and P11C contain the address of the first light emitter 12A, the address of the first light emitter 12B, and the address of the second light emitter 13, respectively.

The light-emitting information field P12 contains the light-emitting information for controlling light-emitting modes such as the color, the light-emitting pattern, and the luminance of the light emitter indicated by the information in the light emitter ID field that is paired with the light-emitting information field P12 in the field pair. For example, the light-emitting information field P12A contains the light-emitting information for controlling the light-emitting modes of the first light emitter 12A. The light-emitting information field P12B contains the light-emitting information for controlling the light-emitting modes of the first light emitter 12B. The light-emitting information field P12C contains the light-emitting information for controlling the light-emitting modes of the second light emitter 13.

The light-emitting control unit 122A of the first light emitter 12A searches the control data P1 received via the input unit 121A for the light emitter ID field containing an address identical to the address held by the address holding unit 123A.

In this embodiment, the address held by the address holding unit 123A coincides with the address contained in the light emitter ID field P11A, and therefore, the light-emitting control unit 122A controls the light-emitting modes of the LED unit 124A in accordance with the light-emitting information contained in the light-emitting information field P12A. The light-emitting control unit 122A outputs the control data P1 to the output unit 125A.

In a case where the light emitter ID field P11 containing an address identical to the address held by the address holding unit 123A does not exist, the light-emitting control unit 122A does not control the LED unit 124A and outputs the control data P1 to the output unit 125A.

Similarly, the light-emitting control unit 122B of the first light emitter 12B searches the control data P1 received via the input unit 121B for the light emitter ID field containing an address identical to the address held by the address holding unit 123B.

In this embodiment, the address held by the address holding unit 123B coincides with the address contained in the light emitter ID field P11B, and therefore, the light-emitting control unit 122B controls the LED unit 124B in accordance with the light-emitting information contained in the light-emitting information field P12B. The light-emitting control unit 122B outputs the control data P1 to the output unit 125B.

In a case where the light emitter ID field P11 containing an address identical to the address held by the address holding unit 123B does not exist, the light-emitting control unit 122B does not control the LED unit 1248 and outputs the control data P1 to the output unit 125B.

Likewise, the light-emitting control unit 132 of the second light emitter 13 searches the control data P1 received via the input unit 131 for the light emitter ID field containing an address identical to the address held by the address holding unit 133.

In this embodiment, the address held by the address holding unit 133 coincides with the address contained in the light emitter ID field P11C, and therefore, the light-emitting control unit 132 controls the LED unit 134 in accordance with the light-emitting information contained in the light-emitting information field P12C.

In a case where the light emitter ID field P11 containing an address identical to the address held by the address holding unit 133 does not exist, the light-emitting control unit 132 does not control the LED unit 134.

As described above, the control signal for transferring the control data P1 in FIG. 12 is transmitted to, in the stacking order, the first light emitter 12A, the first light emitter 12B, and the second light emitter 13, via the electrical serial connection.

For example, the above-described presentation apparatus 10 is, for example, wirelessly connected to an access point and receives the control packet from the access point. An example of a presentation system including the presentation apparatus 10 and an access point is described below.

### Presentation System Using Presentation Apparatus

FIG. 13 illustrates an example of a presentation system 30 according to the first embodiment. FIG. 13 includes two presentation apparatuses 10A and 10B, and an access point 20. It should be noted that the number of the presentation apparatuses 10 is not limited to two. For example, the number of the presentation apparatuses 10 may be one, or three or more. The number of the access points 20 is also not limited to one. For example, the number of the access point 20 may be two or more.

### Configuration of Access Point

FIG. 14 illustrates an example of a configuration of the access point 20 according to the first embodiment. The access point 20 includes a wireless communication unit (wireless communication circuit) 201, a light-emitting control unit (light-emitting control circuit) 202, a light-emitter-information collection unit (light-emitter-information collection circuit) 203, and a control unit (control circuit) 204.

The wireless communication unit 201 includes an antenna and a signal processor (signal processing circuit). The wireless communication unit 201 wirelessly communicates with each of the presentation apparatuses 10 under the control of the control unit 204. The wireless communication unit 201 operates in accordance with a communication standard or a communication system such as a specified low power wireless communication, a wireless LAN, or a Bluetooth (registered trademark). The wireless communication unit 201 may operate in accordance with any communication standards such as LPWA, LoRa, NB-IoT, Sigfox, and cellular communication, which all cover areas broader than the area covered by the Bluetooth communication standard.

The light-emitting control unit 202 controls the light emitter included in the presentation apparatus 10A and the light emitter included in the presentation apparatus 10B. The light-emitting control unit 202 generates a light-emitting control packet to be transmitted to each of the presentation apparatuses 10. The light-emitting control packet contains the control data (see FIG. 12) indicating the presentation pattern.

The light-emitter-information collection unit 203 collects the ID of each of the presentation apparatuses 10 and the number of the first light emitter 12 and/or the second light emitter 13 that are included in each of the presentation apparatuses 10. Specifically, the light-emitter-information collection unit 203 generates the light-emitter-information collection packet for the presentation apparatus 10A and the presentation apparatus 10B and outputs the light-emitter-information collection packet to the control unit 204. The light-emitter-information collection packet is a packet for collecting the number of the first light emitter and the second light emitter that are included in each of the presentation apparatuses.

The light-emitter-information collection unit 203 receives a light-emitter-information notification packet that is transmitted by each of the presentation apparatuses 10 having received the light-emitter-information collection packet. The light-emitter-information notification packet will be described later. The light-emitter-information collection unit 203 holds information on the light emitter contained in the light-emitter-information notification packet.

The control unit 204 controls the wireless communication unit 201, the light-emitting control unit 202, and the light-emitting-information collection unit 203.

For example, the control unit 204 transmits via the wireless communication unit 201 the light-emitter-information collection packet obtained from the light-emitter-information collection unit 203. The control unit 204 receives the light-emitter-information notification packet via the wireless communication unit 201 and outputs the light-emitter-information notification packet to the light-emitter-information collection unit 203.

For example, the control unit 204 transmits via the wireless communication unit 201 the light-emitting control packet obtained from the light-emitting control unit 202.

When the presentation apparatus 10 receives the light-emitter-information collection packet transmitted by the access point 20, the presentation apparatus 10 may report the number of the first light emitter 12 included in the presentation apparatus 10 and/or the number of the second light emitter 13 included in the presentation apparatus 10. Next, the light-emitter-information notification packet, which is used by the presentation apparatus 10 for reporting the number of the first light emitter 12 and/or the number of the second light emitter 13, is described.

### Light-Emitter-Information Notification Packet

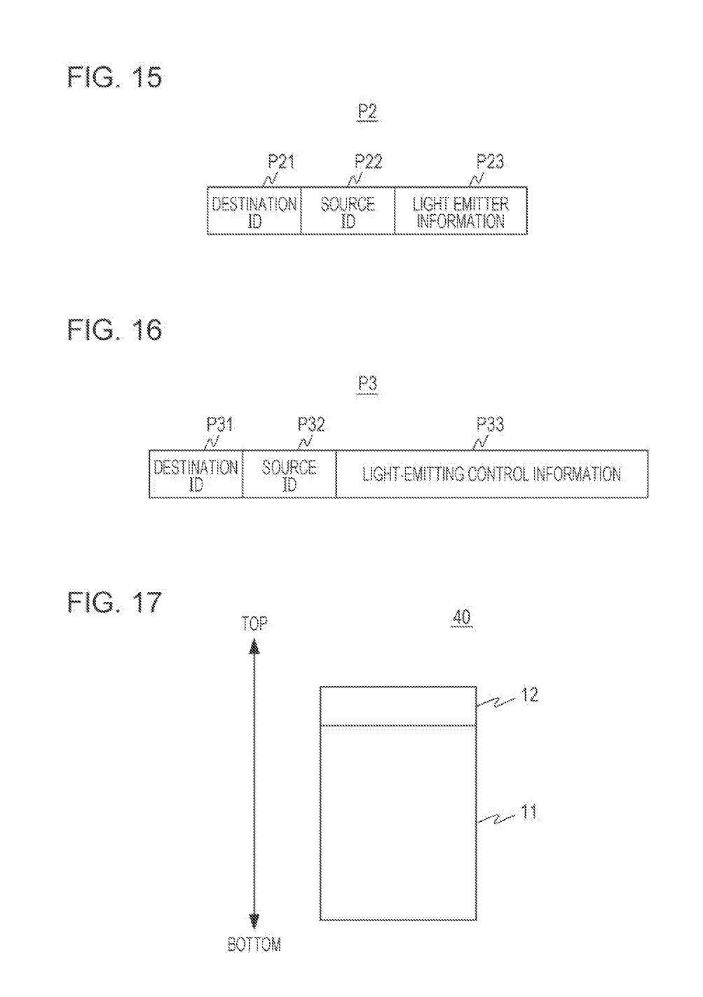

FIG. 15 illustrates an example of a light-emitter-information notification packet P2 according to the first embodiment. The presentation apparatuses 10 each transmit the light-emitter-information notification packet P2 illustrated in FIG. 15 to the access point 20.

The light-emitter-information notification packet P2 includes a destination ID field P21, a source ID field P22, and a light emitter information field P23. The destination ID field P21 contains a unique ID that indicates the access point 20 as the destination of the light-emitter-information notification packet P2. The source ID field P22 contains a unique ID that indicates the presentation apparatus 10 as the source of the light-emitter-information notification packet P2. The light emitter information field P23 contains information on the first light emitter 12 and/or the second light emitter 13 that are included in the presentation apparatus 10 as the source.

The information contained in the light emitter information field P23 includes, for example, the number of the first light emitter and/or the second light emitter that are included in the presentation apparatus 10 as the source. Otherwise, the information contained in the light emitter information field P23 may include the number of the first light emitter and/or the second light emitter and the address of the first light emitter and/or the address of the second light emitter, which both are included in the presentation apparatus 10 as the source.

### Control Packet

FIG. 16 illustrates an example of a configuration of a control packet P3 according to the first embodiment. The access point 20 transmits the control packet P3 illustrated in FIG. 16 to each of the presentation apparatuses 10.

The control packet P3 includes a destination ID field P31, a source ID field P32, and a light-emitting control information field P33. The destination ID field P31 contains at least one ID (for example, a MAC address and/or a device ID) that indicates the presentation apparatus 10 as the destination of the control packet P3. The source ID field P32 contains at least one ID (for example, a MAC address and/or a device ID) that indicates the access point 20 as the source of the control packet P3. The light-emitting control information field P33 contains the control data (see FIG. 12).

Instead of the at least one ID indicating the presentation apparatus 10 as the destination of the control packet P3, the destination ID field P31 may contain a broadcast ID. The control packet P3 containing the broadcast ID in the destination ID field P31 is broadcast to multiple presentation apparatuses 10 (for example, all presentation apparatus 10 that are able to receive the control packet P3).

The destination ID field P31 may contain the group ID in which multiple presentation apparatuses 10 are grouped. The control packet P3 containing the group ID in the destination ID field P31 is broadcast to multiple presentation apparatuses 10, and the presentation apparatuses 10 corresponding to the group ID emit light in accordance with the light-emitting control information contained in the light-emitting control information field P33.

The access point 20 may transmit to each of the presentation apparatuses 10 a beacon containing time information, for the purpose of establishing the synchronization in the wireless network controlled by the access point 20. The control unit 112 of each of the presentation apparatuses 10 that has received the beacon may set the time information managed by the presentation apparatus 10 to be identical to the time information contained in the received beacon.

It should be noted that, although in the above-described example the access point 20 and each of the presentation apparatuses 10 are wirelessly connected to each other, the present disclosure is not limited to this example. For example, the access point 20 and each of the presentation apparatuses 10 may be connected by wire. Another example is that the presentation apparatus 10 that is connected to the access point 20 by wire and the presentation apparatus 10 that is wirelessly connected to the access point 20 both may exist together.

Furthermore, although in the above-described example the presentation apparatus 10 including two first light emitters 12 and one second light emitter 13 is described, the present disclosure is not limited to this example. In accordance with the change in combination of the light emitters, various configurations may be adapted to the presentation apparatus according to the present disclosure. An example of a presentation apparatus having a different combination of the light emitters is described below.

### Example of Combination

FIG. 17 illustrates another example of a configuration of a presentation apparatus 40 according to the first embodiment. The presentation apparatus 40 has, for example, a penlight shape and is used by being gripped by a user.

The presentation apparatus 40 includes the presentation controller 11 and the first light emitter 12. The description of the presentation controller 11 and the first light emitter 12 is omitted here as they have been explained in the description of the presentation apparatus 10.

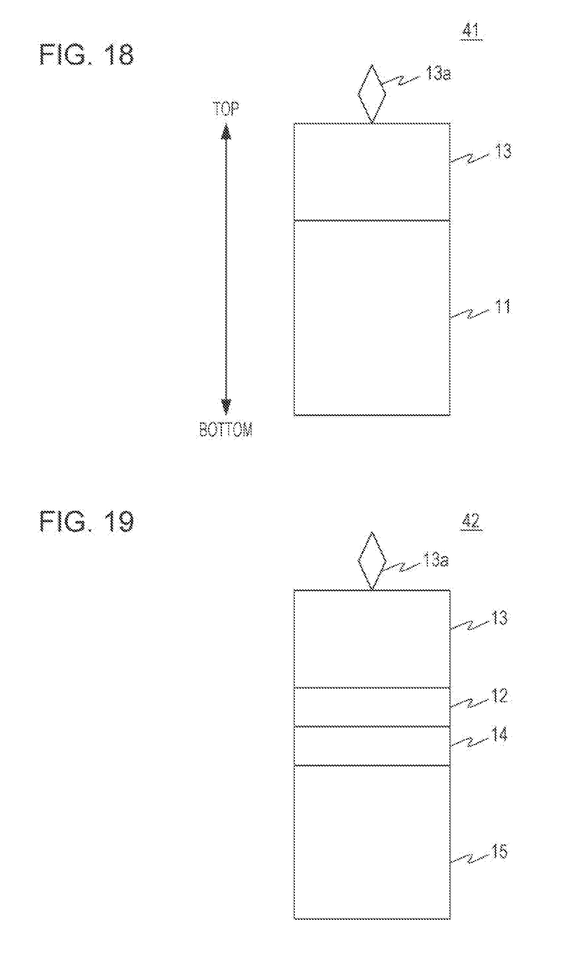

FIG. 18 illustrates a further example of a configuration of a presentation apparatus 41 according to the first embodiment. The presentation apparatus 41 is, for example, similar to the presentation apparatus 10, a candle-shaped LED light that is used at a standing position.

The presentation apparatus 41 includes the presentation controller 11 and the second light emitter 13. The description of the presentation controller 11 and the second light emitter 13 is omitted here as they have been explained in the description of the presentation apparatus 10.

In the presentation apparatus that has an above-described configuration, the first light emitter and/or the second light emitter are attachable to the presentation controller in a stacking manner and detachable from the presentation controller. When the first light emitter and/or the second light emitter are attached to the presentation controller, the output units and the input units form an electrical serial connection. With this configuration, the number of signal lines for connecting the first light emitter and/or the second light emitter can be reduced and even if the number of the first light emitter and/or the second light emitter increases or decreases, the number of signal lines is not necessarily changed. As a result, in accordance with the usage scene, the use case, and/or the content of presentation, the number of the light emitters can be adjusted.

Moreover, by changing the combination of the first light emitter and/or the second light emitter, a variety of presentation can be realized by a single presentation apparatus.

Concerning the connection of the presentation controller and the first light emitter or the second light emitter and the connection of the first light emitter (for example, the first light emitter 12A) and the other first light emitter (for example, the first light emitter 12B) or the second light emitter, by fitting the guide Ga into the guide receiving portion Gb, the presentation apparatus can be easily assembled. Furthermore, by fitting the catch Na into the catch receiving portion Nb, the catch Na and the catch receiving portion Nb are affixed to each other, so that the presentation apparatus can be rigidly assembled.

Although in this embodiment there is described an example in which the presentation controller is attached to the light emitter by fitting the catch Na into the catch receiving portion Nb and fitting the guide Ga into the guide receiving portion Gb, the present disclosure is not limited to this example. For example, the presentation controller may be attached to the light emitter in such a manner that a rail is provided to one of the presentation controller and the light emitter, a groove is provided to the other of the presentation controller and the light emitter, and the rail is fitted into the groove. Another example is that one of the two magnets having different magnetic polarities from each other is provided to one of the presentation controller and the light emitter and the other is provided to the other, so that the presentation controller may be attached to the light emitter by using magnetic force.

It should be noted that the above-described manners for attachment can also be employed for the attachment between two light emitters.

### Second Embodiment

In the above-described first embodiment, an example of the presentation apparatus in which the light-emitting modes are controlled in accordance with the control packet received from the control apparatus (the access point 20) has been described. In the second embodiment, an example of a presentation apparatus in which the light-emitting modes are controlled in accordance with information on a sensor provided to the presentation apparatus and the control packet.

FIG. 19 illustrates an example of a configuration of a presentation apparatus 42 according to the second embodiment. The presentation apparatus 42 includes a presentation controller 15, the first light emitter 12, the second light emitter 13, and a sensor control unit 14. The description of the first light emitter 12 and the second light emitter 13 is omitted as they have been described in the first embodiment.

The presentation apparatus 42 is, for example, a candle-shaped LED light that is used at a standing position. Similar to the presentation apparatus described in the first embodiment, in the presentation apparatus 42, the presentation controller 15, the first light emitter 12, the second light emitter 13, the sensor control unit (sensor control circuit) 14 are attachable to and detachable from one another.

The sensor control unit 14 may also be referred to as a sensor device, a sensor unit, a sensing device, or a sensing unit.

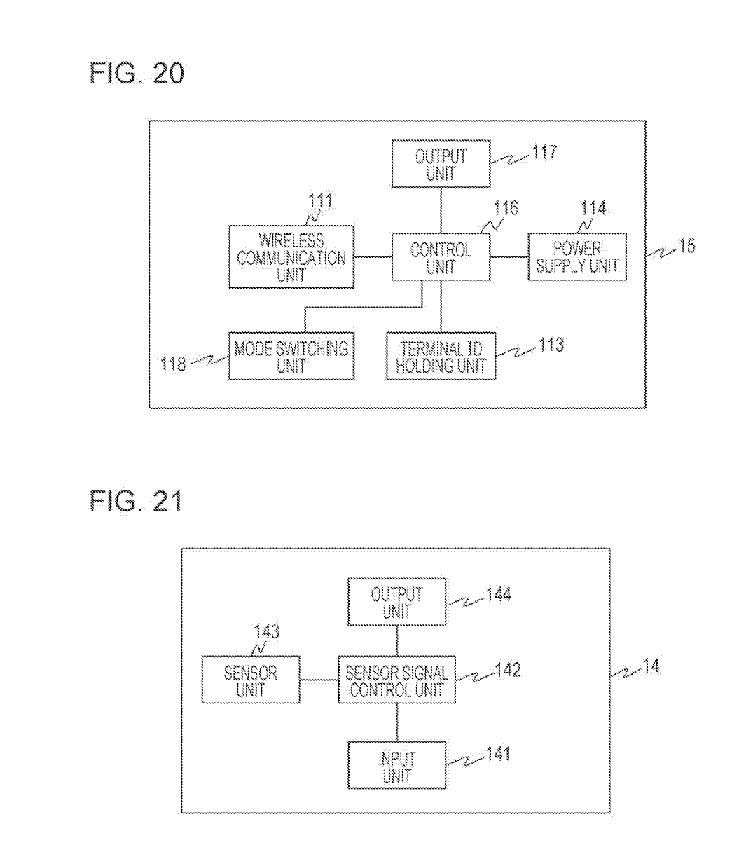

FIG. 20 illustrates an example of a configuration of the presentation controller 15 according to the second embodiment. The presentation controller 15 includes the wireless communication unit 111, a control unit 116, the terminal ID holding unit 113, the power supply unit 114, an output unit 117, and a mode switching unit (mode switching circuit) 118. In the description of FIG. 20, the same configurations as in FIG. 2 are numbered with the same reference numbers as in FIG. 2 and the description of the same configurations is omitted.

The mode switching unit 118 generates mode information indicating any one of the mode (hereinafter referred to as the sensor signal priority mode) in which priority is given to a sensor signal obtained from the sensor control unit 14 and the mode (hereinafter referred to as the control signal priority mode) in which priority is given to the control packet received from the access point 20 (see FIG. 13). The mode switching unit 118 outputs the mode information to the control unit 116.

The mode switching unit 118 may generate the mode information in accordance with the user's operation and/or a signal transmitted from an external location. For example, the mode switching unit 118 generates the mode information in accordance with a user's operation that is received by using a switch (for example, a dual in-line package (DIP) switch) provided to the presentation controller 15. The mode switching unit 118 may generate the mode information in accordance with a signal received from the access point 20.

In addition to the function of the control unit 112 described in the first embodiment, the control unit 116 has a function of controlling the first light emitter 12 and the second light emitter 13 in accordance with the mode information obtained from the mode switching unit 118.

In a case where the mode information indicates the sensor signal priority mode, the control unit 116 controls light emission (light on or off) of the first light emitter 12 and the second light emitter 13 in accordance with the sensor signal regardless of whether the control packet is received from the access point 20 (see FIG. 13). In this case, the control unit 116 outputs the control signal for transferring the control data for the preset sensor signal priority mode to the first light emitter 12 and the second light emitter 13 via the output unit 117.

In a case where the mode information indicates the control signal priority mode, the control unit 116 controls light emission (light on or off) of the first light emitter 12 and the second light emitter 13 in accordance with the control packet obtained from the access point 20.

The sensor signal priority mode or the control signal priority mode may be set individually for the respective light emitters. For example, the first light emitter 12 may be set to the sensor signal priority mode and the second light emitter 13 may be set to the control signal priority mode. In this case, the control unit 116 controls the first light emitter 12 in accordance with the sensor signal and the second light emitter 13 in accordance with the control packet.

The output unit 117 outputs to the sensor control unit 14 the control signal for transferring the control data that is output from the control unit 116. The output unit 117 obtains the sensor signal from the sensor control unit 14 and outputs the sensor signal to the control unit 116.

FIG. 21 illustrates an example of a configuration of the sensor control unit 14 according to the second embodiment. The sensor control unit 14 includes an input unit (input terminal) 141, a sensor signal control unit (sensor signal control circuit) 142, a sensor unit (sensor circuit) 143, and an output unit (output terminal) 144.

The input unit 141 obtains the control signal from the presentation controller 15 and outputs the control signal to the sensor signal control unit 142. The input unit 141 may be a terminal for inputting and outputting signals. The input unit 141 obtains the sensor signal from the sensor signal control unit 142 and outputs the sensor signal to the presentation controller 15.

The sensor unit 143 includes, for example, one or more of a human presence sensor, a temperature sensor, a humidity sensor, a gas sensor, and an illuminance sensor. The sensor unit 143 outputs detected information to the sensor signal control unit 142.

The sensor signal control unit 142 generates a sensor signal indicating a trigger for controlling light emission of the presentation apparatus 42 in accordance with information obtained from the sensor unit 143.

The trigger for controlling light emission of the presentation apparatus 42 may include at least one of a trigger for starting the control of light emission of the presentation apparatus 42, a trigger for ending the control of light emission, and a trigger for changing the control of light emission (switching the light-emitting modes of the light emitter).

For example, the trigger for controlling light emission of the presentation apparatus 42 corresponds to the case where the information obtained from the sensor unit 143 satisfies a predetermined condition. One example is that, in a case where the sensor unit 143 includes a temperature sensor, the trigger for controlling light emission is to satisfy the condition in which the temperature obtained by the sensor unit 143 is equal to or higher than a predetermined value. Another example is that, in a case where the sensor unit 143 includes a human presence sensor, the trigger for controlling light emission of the presentation apparatus 42 is to satisfy the condition in which a person is detected within a detection area of the human presence sensor.

The sensor signal control unit 142 outputs the sensor signal to the input unit 141. The sensor signal control unit 142 also outputs the control signal obtained from the input unit 141 to the output unit 144.

The output unit 144 outputs the control signal obtained from the sensor signal control unit 142 to the first light emitter 12.

The sensor control unit 14 performs transfer processing for the control signal. The sensor control unit 14 also performs transfer processing for the number-check control command and the reply to the number-check control command, which are described in the first embodiment.

The exterior of the sensor control unit 14 is the same as that of the first light emitter 12, and thus the detailed description is omitted. However, the sensor control unit 14 differs from the first light emitter 12 in that the sensor control unit 14 does not include the address holding unit 123 and the side of the sensor control unit 14 does not emit light.

Similarly to the first embodiment, in the presentation apparatus according to the second embodiment, the first light emitter and/or the second light emitter can be coupled to other components in a cascade manner, and thus, the number of signal lines for connecting the first light emitter and/or the second light emitter can be reduced and even if the number of the first light emitter and/or the second light emitter increases or decreases, the number of signal lines is not necessarily changed. As a result, in accordance with the usage scene, the use case, and/or the content of presentation, the number of the first light emitter and/or the second light emitter can be adjusted.

Furthermore, in terms of the presentation apparatus according to the second embodiment, similar to the first embodiment, by changing the combination of the first light emitter and/or the second light emitter, a variety of presentation can be realized by a single presentation apparatus.

Moreover, the presentation apparatus according to the second embodiment is able to control the light-emitting modes in accordance with the control packet received from the control apparatus (the access point 20) and information obtained by the sensor provided to the presentation apparatus, and as a result, a variety of presentation can be realized by a single presentation apparatus.

Although in the second embodiment there is described an example in which the sensor control unit 14 is coupled between the presentation controller 15 and the first light emitter 12, the present disclosure is not limited to this example. The sensor control unit 14 may be coupled between the second light emitter 13 and the first light emitter 12.

Furthermore, although in the second embodiment there is described an example in which the sensor control unit 14 has a different configuration (a different unit) from that of the presentation controller 15 and that of the light emitter, the present disclosure is not limited to this example. For example, the function of the sensor control unit 14 may be included in the presentation controller 15. Otherwise, the function of the sensor control unit 14 may be included in at least one of the light emitters.

The functional blocks used in the description of the above embodiments are typically implemented as the large scale integration (LSI) serving as an integrated circuit. The integrated circuit controls the functional blocks used in the description of the above embodiments and may include an input and an output. These functional blocks each may be made individually into one chip or one chip may be made to include some of the functional blocks or all functional blocks. The integrated circuit referred to as the LSI here may be referred to as an IC, a system LSI, a super LSI, an ultra LSI, depending on the integration degree.

The method of implementing the integrated circuit is not limited to LSI, but may be implemented as a dedicated circuit or a general processor. A Field Programmable Gate Array (FPGA) that is programmable after manufacturing of the LSI or a reconfigurable processor in which connection or setting of circuit cells in the LSI can be reconfigured after manufacturing of LSI may be employed.

If an integrated-circuit technology that would supersede the LSI emerges due to the progress of the semiconductor technology or a derivative related technology, the technique may be used for integrating functional blocks. Biotechnology may possibly be applicable.

It should be noted that the present disclosure may be expressed as a control method performed by a wireless communication apparatus or a control apparatus. Furthermore, the present disclosure may be expressed as a program for causing a computer to perform the control method. Moreover, the present disclosure may be expressed as a storage medium storing the program in a computer-readable state. Therefore, the present disclosure can be expressed in any category of the apparatus, the method, the program, and the storage medium.

Referring to the drawings, the various kinds of embodiments have been described, but the present disclosure is not limited to the embodiments. It is apparent that various changes and modifications may occur to those skilled in the art within the scope of the claims, and these are intended to be embraced in the technical range of the present disclosure. In addition, the components in the above-described embodiments may be arbitrary combined without departing from the spirit and scope of the present disclosure.

### Conclusion of Present Disclosure

The presentation apparatus of the present disclosure includes a controller that includes a first output terminal for outputting a control signal and first to nth (n is an integer equal to or more than 1) light emitters that each include a first input terminal to which the control signal is input and that is each attachable to the controller in a stacking manner and detachable from the controller. The control signal is transferred to the first to nth light emitters in a stacking order via an electrical serial connection.

In the presentation apparatus of the present disclosure, the stacked first to nth light emitters each transmit address information to the controller, and the controller obtains a number of the stacked first to nth light emitters in accordance with the address information on the first to nth light emitters.

In the presentation apparatus of the present disclosure, a light-emitting mode of at least one of the first to nth light emitters is controlled by using the control signal according to the number of the stacked first to nth light emitters.

In the presentation apparatus of the present disclosure, at least the first to n-1 light emitters of the stacked first to nth light emitters each include a second output terminal for outputting the control signal, and first input terminals and second output terminals of the stacked first to n-1 light emitters are disposed coaxially in a stacking direction in which the first to nth light emitters are stacked.

In the presentation apparatus of the present disclosure, at least one of the first to nth light emitters has a cylindrical shape whose axis extends in the stacking direction.

In the presentation apparatus of the present disclosure, the presentation apparatus has an exterior that mimics a candle.

In the presentation apparatus of the present disclosure, the controller includes a wireless communication circuit that receives information indicating a pattern for controlling the light-emitting mode of at least one of the first to nth light emitters, and a control signal generation circuit that generates the control signal in accordance with the information indicating the pattern and outputs the control signal from the first output terminal.

The presentation apparatus of the present disclosure further includes a sensor that is stacked on the controller or any one of the first to nth light emitters and that performs sensing in an environment around the presentation apparatus. The controller generates the control signal in accordance with a sensing result obtained by the sensor.

The present disclosure is applicable to a presentation apparatus such as a penlight whose components can be differently assembled.

What is claimed is:

1. A presentation apparatus comprising;
a controller that includes a first output terminal for outputting a control signal; and
first to nth (n is an integer equal to or more than 1) light emitters that each include a first input terminal to which the control signal is input and that is each attachable to the controller in a stacking manner and detachable from the controller, wherein
the control signal is transferred to the first to nth light emitters in a stacking order via an electrical serial connection.

2. The presentation apparatus according to claim 1, wherein
the stacked first to nth light emitters each transmit address information to the controller, and
the controller obtains a number of the stacked first to nth light emitters in accordance with the address information on the first to nth light emitters.

3. The presentation apparatus according to claim 2, wherein a light-emitting mode of at least one of the first to nth light emitters is controlled by using the control signal according to the number of the stacked first to nth light emitters.

4. The presentation apparatus according to claim 1, wherein
at least the first to n-1 light emitters of the stacked first to nth light emitters each include a second output terminal for outputting the control signal, and
first input terminals and second output terminals of the stacked first to n-1 light emitters are disposed coaxially in a stacking direction in which the first to nth light emitters are stacked.

5. The presentation apparatus according to claim 1, wherein at least one of the first to nth light emitters has a cylindrical shape whose axis extends in a stacking direction.

6. The presentation apparatus according to claim 1, wherein the presentation apparatus has an exterior that mimics a candle.

7. The presentation apparatus according to claim 1, wherein the controller includes
a wireless communication circuit that receives information indicating a pattern for controlling a light-emitting mode of at least one of the first to nth light emitters, and
a control signal generation circuit that generates the control signal in accordance with the information indicating the pattern and outputs the control signal from the first output terminal.

8. The presentation apparatus according to claim 1, further comprising a sensor that is stacked on the controller or any one of the first to nth light emitters and that performs sensing in an environment around the presentation apparatus, and wherein
the controller generates the control signal in accordance with a sensing result obtained by the sensor.
